(19) United States
(12) Patent Application Publication
(10) Pub. No.: US 2017/0326037 A1
(43) Pub. Date: Nov. 16, 2017

(54) Baby Pacifier for a Breast Fed Child

(71) Applicants: Jane M. Molina, St. Louis, MO (US); Joy M. Williams, Ferguson, MO (US)

(72) Inventors: Jane M. Molina, St. Louis, MO (US); Joy M. Williams, Ferguson, MO (US)

(21) Appl. No.: 15/657,485

(22) Filed: Jul. 24, 2017

Related U.S. Application Data
(63) Continuation of application No. 15/185,779, filed on Jun. 17, 2016, now abandoned.
(60) Provisional application No. 62/182,137, filed on Jun. 19, 2015.

(51) Int. Cl. A61J 17/00

(52) U.S. Cl. CPC A61J 17/008

(57) ABSTRACT

A pacifier that simulates the natural shape, structure and consistency of a mother's breast. The pacifier includes a teat portion with a nipple and areola attached to a mouth shield. The teat portion has a length such that it bears against the hard palate of a baby in use.

### BACKGROUND OF THE INVENTION

### 1. Field of the Invention

The present invention relates to an infant pacifier that simulates the natural shape, structure and consistency of a human breast in use such that when an infant is latched onto the areola area behind the nipple the infant's lips are flanged out and the nipple makes proper contact with the hard palate.

### 2. Brief Description of the Prior Art

The benefits of breast feeding for an infant and for a mother are well established. It is difficult, however, for a mother to necessarily be available to satisfy all the non-nutritive sucking needs of her baby. For example, some women do at times suffer from the discomfort of having cracked and bleeding nipples. Also, for all nursing mothers, and particularly working nursing mothers, it would be highly desirable to have a pacifier that accurately simulated her breast for non-nutritive sucking while the infant and mother are separated.

Currently available pacifiers however do not satisfy the above goal. With a common pacifier, the nipple collapses under the pressure from the infant's mouth and the infant cannot bring the nipple back into its mouth and onto the soft palate. The oral motor skills that an infant uses during breast feeding are different. In nursing, the nipple is in contact with the baby's palate while the baby's tongue exerts a force on a second portion of the nipple.

It is not unusual for a baby to reject the currently available pacifiers because the infant is only familiar with the physical movements necessary for nutritive sucking. On the other hand, once a baby has accepted a pacifier, the baby may reject the mother's breasts. A nursing mother is thus presented with a dilemma yet needs relief from the non-nutritive sucking needs of her offspring.

### BRIEF SUMMARY OF THE INVENTION

In view of the above, it is an object of the present invention to provide an infant pacifier that in use simulates the sucking action in nutritive feeding from a human breast. It is another object to provide a pacifier that when an infant is latched onto the areola area behind the nipple the infant's lips are flanged out and the nipple makes contact with the hard palate. It is also an object to provide a pacifier that is less likely to be rejected by a nursing baby and which is less likely to result in nipple confusion leading to breast rejection. Other objects and features of the invention will be in part apparent and in part pointed out hereinafter.

In accordance with the invention, an infant pacifier simulating the shape, structure and consistency of a human breast includes a teat portion including a nipple and areola attached to a mouth shield portion, said teat portion formed of a plastic material and having a length such that in use a distal end bears against the hard palate of a baby. Other features of the infant pacifier are disclosed below.

The invention summarized above comprises the constructions hereinafter described, the scope of the invention being indicated by the subjoined claims.

### BRIEF DESCRIPTION OF THE SEVERAL VIEWS OF THE DRAWING

In the accompanying drawings, in which an embodiment of the invention is illustrated, corresponding reference characters refer to corresponding parts throughout the several views of the drawings in which:

FIG. 1 is an X-ray perspective view of a pacifier in accordance with the present invention;

FIG. 2 is a side elevation of the pacifier;

FIG. 3 is a side elevation of the pacifier rotated 90 degrees from FIG. 2;

FIG. 4 is a top plan view of the pacifier;

FIG. 5 is a perspective view of a base ring embedded in the pacifier;

FIG. 6 is a plan view of the base ring;

FIG. 7 is a side elevation of the base ring;

FIG. 8 is a diagram showing the pacifier in use; and,

FIG. 9 is a photograph of a pacifier.

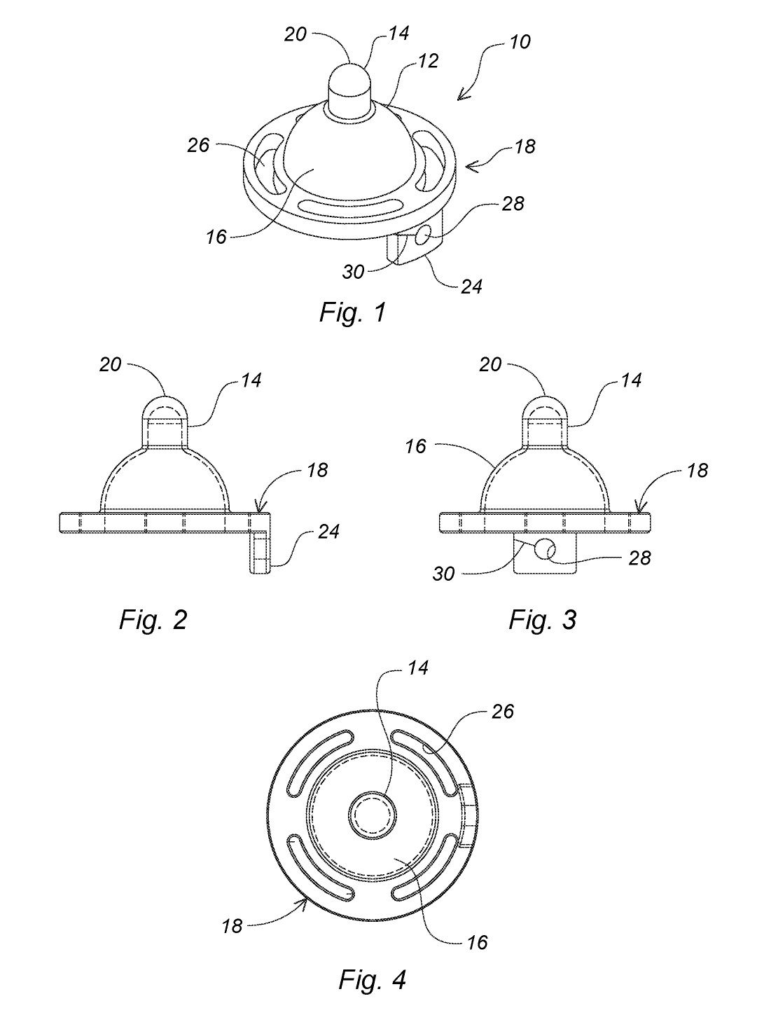

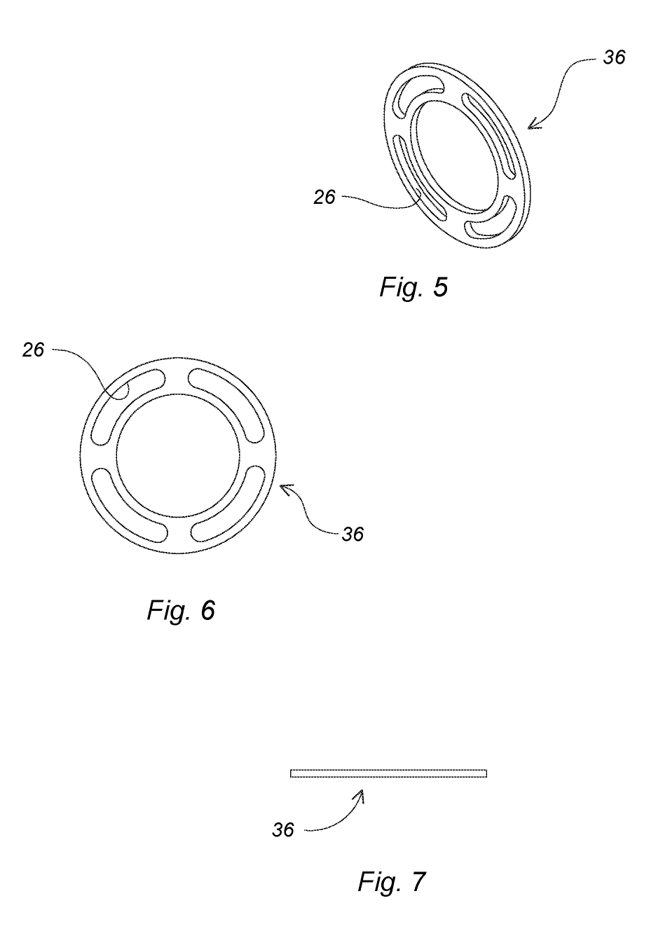

### DETAILED DESCRIPTION OF THE INVENTION

The following detailed description is merely exemplary in nature and is not intended to limit the described embodiments or the application and uses of the described embodiments. As used herein, the word “exemplary” or “illustrative” means “serving as an example, instance, or illustration.” Any implementation described herein as “exemplary” or “illustrative” is not necessarily to be construed as preferred or advantageous over other implementations. All of the implementations described below are exemplary implementations provided to enable persons skilled in the art to make or use the embodiments of the disclosure and are not intended t limit the scope of the disclosure, which is defined by the claims. For purposes of description herein, the terms “upper,” “lower,” “left,” “rear,” “right,” “front,” “vertical,” “horizontal,” and derivatives thereof shall relate to the invention as oriented in Drawing A. Furthermore, there is no intention to be bound by any expressed or implied theory presented in the preceding technical field, background, brief summary or the following detailed description. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

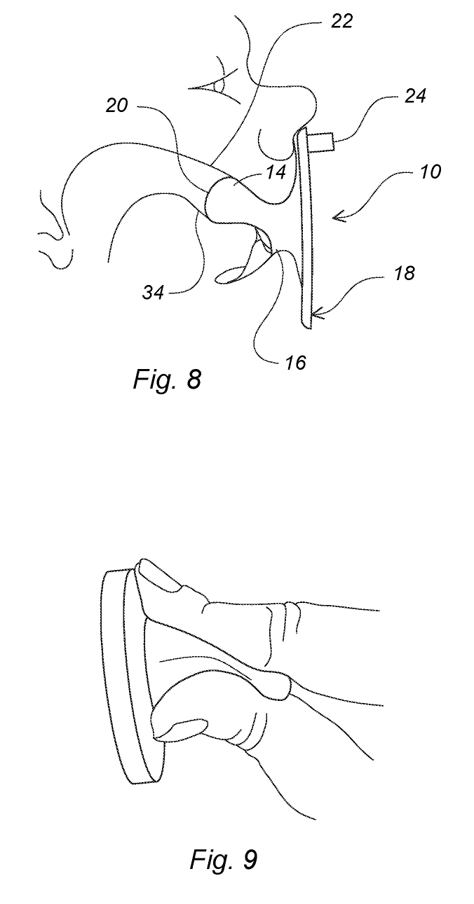

Referring it drawings more particularly by reference character, a pacifier 10 in accordance with the present invention includes a teat portion 12 with a nipple 14 and an areola 16 for insertion into a baby's mouth and a mouth shield portion 18. Mouth shield portion 18 fits over the baby's face around the mouth and serves in use to limit the extent of insertion of teat portion 12 into the baby's mouth. Teat portion 12 has a length such that in use a distal end 20 as shown in FIG. 8 bears against the hard palate 22 in the roof an infant's mouth. A handle 24 is attached to mouth shield portion 18 with breathing vents 26 and an aperture 28 through which a cord maybe passed for securing pacifier 10 to a supporting surface. A safety release slit 30 may be provided in aperture 28.

The overall goal of pacifier 10 is to mimic the functionality, texture, shape and dimensions of a mother's areola and nipple. Specific details of an exemplary embodiment are as follows:
Nipple 14 may be formed of a silicone such as Silicone Shore A20 hardness. The nipple is the portion that the baby will roll their tongue over. As shown in FIG. 3, the wall thickness may be about 0.05″.
Areola 16 may be formed of the same silicone material but with a wall thickness of about 0.04″ to give a more elastic feeling and stretch (as shown in FIG. 9) such that it collapses easily between the roof of the baby's mouth, gums and tongue.
Mouth shield 18 includes an embedded base ring 36 shown in FIGS. 5-7. Base ring 36 is rigid and is formed of polycarbonate or the like.
Breathing vents 26 may be provided through mouth shield 18 and base ring 36 to allow a baby to breathe well with pacifier 10 in his or her mouth.
The handle portion 24 as seen in FIG. 3 is rectangular in shape and formed of silicone with a hole 28 and a tight slit 30 that goes from the hole to the outside of the handle—allowing a pacifier clip to slide through and attached to a baby's clothing to prevent the pacifier from falling on the floor. Slit 30 provides a cord release to prevent choking or getting the baby caught on something it needs to be released from.

The silicone used for nipple 14, areola 16 and mouth shield 18 is highly inert, does not react with most chemicals and may be molded. The polycarbonate used for base ring 36 has superior impact resistance (toughness), temperature resistance and high clarity. It can be injection molded, thermoformed or extruded. Base ring 36 is formed first and base portion 18 molded around it.

FIG. 8 illustrates pacifier 10 in use with the baby's tongue 34 making contact with one side of nipple 14 and pressing the nipple against the hard palate 22.

In the above description, numerous specific details are set forth such as examples of some embodiments, specific components, devices, methods, in order to provide a thorough understanding of embodiments of the present disclosure. It will be apparent to a person of ordinary skill in the art that these specific details need not be employed, and should not be construed to limit the scope of the disclosure. In the development of any actual implementation, numerous implementation-specific decisions must be made to achieve the developer's specific goals, such as compliance with system-related and business-related constraints. Such a development effort might be complex and time consuming, but is nevertheless a routine undertaking of design, fabrication, and manufacture for those of ordinary skill. Hence as various changes could be made in the above constructions without departing from the scope of the invention, it is intended that all matter contained in the above description or shown in the accompanying drawings shall be interpreted as illustrative and not in a limiting sense.

What is claimed:

1. A baby pacifier for a breast fed child simulating the shape, structure and consistency of a human breast, said pacifier including a teat portion including a nipple and areola attached to a mouth shield portion, said teat portion formed of a plastic material and having a length such that in use a distal end bears against the hard palate of a baby.

2. The pacifier of claim 1 wherein the nipple is formed of a silicone with a dense, squishy and soft texture.

3. The pacifier of claim 2 wherein the areola is formed of a silicone with a more elastic feeling than the nipple and a texture that collapses easily between the roof of a baby's mouth, gums and tongue.

4. The pacifier of claim 1 wherein the mouth shield includes an embedded base ring formed of polycarbonate.

5. The pacifier of claim 4 wherein breathing vents are provided in the mouth shield and base ring.

6. The pacifier of claim 1 further comprising a handle attached to the mouth shield, said handle having a safety release slit for allowing a pacifier cord or clip to slide through to attach the pacifier to a baby's clothing and prevent the pacifier from falling on the floor and to provide a clip or cord release.
